(19) United States
(12) Patent Application Publication
(10) Pub. No.: US 2002/0146618 A1
(43) Pub. Date: Oct. 10, 2002

(54) Cathode formulations for super-iron batteries

(75) Inventor: Stuart Licht, Haifa (IL)

Correspondence Address: BROWDY AND NEIMARK, P.L.L.C., 624 NINTH STREET, NW, SUITE 300, WASHINGTON, DC, 20001-5303, US

(73) Assignee: CHEMERGY, Energy Technologies, Technion City (IL)

(21) Appl. No.: 10/061,303

(22) Filed: Feb. 4, 2002

(30) Foreign Application Priority Data
Feb. 4, 2001 (IL) 141260

(51) Int. Cl. H01M 4/52; H01M 4/58; H01M 8/20

(52) U.S. Cl. 429/107; 429/221

(57) ABSTRACT

An electric storage battery comprising an electrically neutral alkaline ionic conductor, an anode and a Fe(VI) salt cathode, and having new Fe(VI) salt cathode formulations. The high +6 valence state of the iron in said salt provides the advantage of a high storage capacity, high voltage, and an environmental advantage. The new formulations improve the lifetime of the salt during storage and during battery discharge. The anode may be any of a large variety of conventional anode materials capable of being oxidized.

The present invention relates to electric storage batteries. More particularly, the invention relates to a novel electric storage battery with an iron salt as cathode.

### BACKGROUND OF THE INVENTION

There is an ongoing need for providing novel improved electrical storage batteries, which are low-cost, have a high-energy density and are environmentally acceptable. Among the main types of storage batteries are those in which the cathodes (the positive electrodes) are based on any of PbO₂, HgO, MnO₂ and NiOOH which are known to possess a theoretical capacity in the range of between 224 to 308 Ah/g. However, these cathode materials are considered as hazardous or environmentally unfriendly.

In U.S. Pat. No. 5,429,894, iron-silver (iron in its zero valence state) was suggested as a battery anode (negative). Iron salts in the +2 and +3 valence state, were also suggested as a battery cathode in the past as described, for example, in U.S. Pat. No. 4,675,256 and U.S. Pat. No. 4,795,685.

Prima facie, salts containing iron in the +6 valence state, hereafter called Fe(VI), which are capable of multiple electron reduction, would be capable to provide a higher cathode storage capacity. However, decomposition with reduction of the iron to a less oxidized form (i.e. to a lower valence state) occurs very rapidly, the stability of Fe(VI) salt solutions being only the order of a few hours at room temperature (Anal. Chem. 23, 1312-4, 1951). The Fe(VI) salts may be made by chemical oxidation, such as reported by G. Thompson (J. Amer. Chem. Soc. 73, 1379, 1951), or by precipitation from another Fe(VI) salt, such as reported by J. Gump et al. (Anal. Chem. 26, 1957, 1954). However, as mentioned in a later report by H. Goffet al (J. Amer. Chem. Soc. 93, 6058-6065, 1971), only little is known on the chemistry of Fe(VI) salts.

In a recent U.S. Pat. No. 6,033,343, a high electric storage capacity battery having an iron salt cathode, with the iron in the greater than Fe(III) valence state was suggested, including up to Fe(VI) valence solid iron salts. The resultant discharge product of such a battery includes Fe₂O₃ which is environmentally more friendly than any of PbO₂, HgO, MnO₂ and NiOOH.

It is an object of the present invention to provide a novel type of battery with new Fe(VI) formulations which is inexpensive, highly stable, possesses a high storage capacity, a high voltage and is environmentally friendly, a battery using additives which can further improve the electrochemical characteristics of the battery.

### BRIEF DESCRIPTION OF THE INVENTION:

The invention relates to an electrical storage cell, so-called battery, comprising two half-cells which are in electrochemical contact with one another through an electrically neutral ionic conductor, wherein one of said half-cells comprises an anode and the other half-cell comprises a cathode in the form of new formulations of a solid-phase Fe(VI) salt in an amount of at least 1% of the half-cell weight, whereby electrical storage is accomplished via electrochemical reduction to a valence of iron salt less than Fe(VI). The high +6 valence state of the iron in said salt provides the advantage of a high storage capacity and high voltage, and iron salts provide an environmental advantage over more toxic materials used for electrochemical electric storage. The new formulations of the Fe(VI) salt can improve the lifetime of the salt during storage and during battery discharge.

### BRIEF DESCRIPTION OF THE FIGURES

FIG. 1 is a diagrammatic illustration of an Fe(VI) battery according to the Invention; and

FIGS. 2 to 5: illustrate graphically performance of various battery aspects according to the invention as described in the Examples.

### DETAILED DESCRIPTION OF THE INVENTION

The novel cathode formulations is based on a battery containing a Fe(VI) (hereafter occasionally referred to as “super iron”) half cell serving as cathode, in contact with an anode half cell through an electrically neutral ionic conductor. The Fe(VI) salt, e.g. M₂FeO₄ where M is an alkali cation or ammonium, may be prepared by oxidation of iron. Further typical examples of Fe(VI) salts are Mₓ(FeO₄)y where M is a cation from the group of alkali earth metal cations, transition metal cations, and cations of elements of groups III, IV, including organic cations, and V of the periodic table, or from the lanthanide and actinide series. Similarly Fe(VI) salts in addition to oxygen, can contain hydroxide and/or other anions, Z, and of the generalized form: MₓFeZ_{y}, and can contain multiple Fe(VI) groups.

The cathodic charge capacity of these salts can be unusually high for battery storage. Without being bound to any theory, the discharge in this battery is based on the electrical storage capacity of these Fe(VI) salts, and is given by their electrochemical reduction or charge intercalation by an ion, C^{Z+}:

Fe(s>III) salt+ne³¹ →Fe(s−n) salt or salts (1)

Fe(s>III) salt+xC^{Z+}→Fe(s−ny) salt or salts+xC^{z-y} (2)

Examples of these reactions with solvent and specific salts, and without being bound to any theory, are given by a three electron reduction or lithium cation intercalation of a super-iron oxide salt, M FeO₄, such as M=K₂, Ba, Li₂, etc.:

MFe(VI)O₄+3e⁻→1/2Fe₂O₃+MO (3)

MFeO₄+xLi⁺+xe⁻→LiₓMFeO₄(M=K₂, Ba, Li₂, etc.) (4)

The Fe(VI) synthesis method can effect battery performance. Several chemical oxidation methods have been suggested, but among methods which yield Fe(VI) salts of highest purity is the one reported by G. Thompson (J. Amer. Chem. Soc. 73, 1379, 1951). By this method, Fe(VI) salts are obtained through the reaction of a solution of hydroxide and hypochlorite (such as NaOH and NaOCl) with an Fe(III) salt, such as Fe(NO₃)₃, as illustrated below:

2Fe(OH)₃+3ClO⁻+4OH⁻→2FeO₄⁻²+3Cl⁻+5H₂O (5)

and the resulting Fe(VI) salt (such as K₂FeO₄) is recovered by precipitation from a less soluble solution (such as concentrated KOH), and is then cleaned and dried. Several Fe(VI) syntheses methods which include precipitation from another Fe(VI) salt have been suggested, but the method which yields among the highest purity Fe(VI) salts is the method reported by J. Gump et al. (Anal. E Chem. 26, 1957, 1954). By this method, Fe(VI) salts may be obtained through the reaction of an existing Fe(VI) salt (such as K₂FeO₄) with a soluble salt (such BaCl₂ or BaNO₃) to precipitate another Fe(VI) salt (such as BaFeO₄).

New formulations of the Super-iron cathode salt can improve the lifetime of the cathode. An Fe(VI) salt which is dry, but not overly dry will retain a longer cathodic charge storage capacity. In one embodiment, the Fe(VI) salt is between 68% and 99% dry, with application of vacuum and drying time sufficient to reach the water removal. The charge capacity can be determined by chemical redox titration, and the water removal can be measured by the mass loss of the salt. In a preferred embodiment the Fe(VI) salt is between 88% and 98% dry.

In another embodiment, a new formulation of a Super-iron cathode salt is prepared, and during its preparation is formed as a solid from another Super-iron salt maintained within an insoluble condition. Without being bound to any theory, this exclusion of dissolved phase Fe(VI) improves the Super-iron lifetime. In a preferred embodiment, a solid Super-iron salt such as K₂FeO₄, is treated with a solid salt or with a solution with which it is highly insoluble, such as a concentrated, or saturated, barium, or strontium hydroxide solution to form a new insoluble Super-iron salt, such as BaFeO₄ or SrFeO₄.

In another embodiment the Super-iron salt is coated with a permanganate salt to improve the barium super-iron salt lifetime. Typical permanganate compounds are illustrated by MMnO₄, or Mn₂O₇, M being an alkali cation. Another typical example of permanganate salts contain alkali earth, M′ cations, other typical examples include a cation, selected from the group consisting of the transition metal cations, or containing cations of group III, group IV (including organic cations) and group V elements. In a preferred embodiment this coating is with a potassium permanganate salt.

In another embodiment, a Super-iron salt is formulated with more than one different cation to improve the Super-iron salt lifetime. In this embodiment, a starting super-iron salt is used in the preparation containing a cation, and during the preparation this cation is only partially replaced by one or more different cations, by addition of a salt containing one or more different cations, resulting in a super-iron formulation which includes both the starting and different cations. The starting super-iron salt can include the aforementioned Fe(VI) salts, e.g. examples thereof include, but are not limited to K₂FeO₄, Na₂FeO₄, Li₂FeO₄, Cs₂FeO₄, Rb₂FeO₄, H₂FeO_{4,} (NH₄)₂FeO_{4,} (N(C₄H₉)₄)₂FeO₄, BeFeO₄, MgFeO₄, CaFeO₄, SrFeO₄, BaFeO₄, BaFeO₄.H₂O, BaFeO₄.2H₂O, La₂(FeO₄)₃, CeFeO₄.2H₂O, Ce₂(FeO₄)₃, Hg₂FeO₄, HgFeO₄, Cu₂FeO₄, CuFeO₄, ZnFeO₄, Ag₂FeO₄, FeO₃, FeFeO₄, Fe₂(FeO₄)₃, CrFeO₄, MnFeO₄, NiFeO₄, CoFeO₄, Al₂(FeO₄)₃, In₂(FeO₄)₃, Ga₂(FeO₄)₃, Sn(FeO₄)₂, Pb(FeO₄)₂. Sn(FeO₄)₂, Pb(FeO₄)₂. The second salt, can include these cations from the group of alkali earth metal cations, transition metal cations, and cations of elements of groups III, IV, including organic cations, and V of the periodic table, or from the lanthanide and actinide series, as well as anions containing oxygen, including hydroxide, or also others which include, but are not limited to: acetates, acetylsalicylates, aluminates, aluminum hydrides, amides, antomonides, arsenates, azides, benzoates, borates, bromides, bromates, carbides, carbonates, chlorates, perchlorates, chlorides, hypochlorites, chlorites, dithiones, chloroplatinates, chromates, citrates, fluorides, fluosilicates, fluosulfonates, formates, gallium hydrides, gallium nitrides, germanates, hydrides, iodates, iodides, periodate, laurates, manganates, malonates, permanganates, hydrocarbon anions, molybdates, myristates, nitrates, nitrides, nitrites, oxalates, oxides, palmitates, phosphates, salicylates, selenates, selenides, silicates, silicides, stearates, succinates, sulfates, sulfides, sulfites, tartrates, thiocyanates, thionates, titanates, tungstates, halides, or chalcogenides.

In another embodiment the Super-iron salt is formulated with a second salt which comprises a significant weight fraction of the Super-iron salt and second salt combined mass. The second salt is chosen such that in the presence of the Super-iron salt, it exhibits an improved lifetime during discharge. In one embodiment in the formulation, the second salt is, added as 1 to 25 weight percent CsOH which may be added as a solid, or mixed in as a CsOH solution. In a preferred embodiment the second salt a manganate or a permanganate salt, comprising a weight fraction between 25% and 99% of the combined mass with the Super-iron salt. Typical permanganate compounds are illustrated by MMnO₄, or Mn₂O₇, and typical manganate compounds are illustrated by M₂MnO₂, M being an alkali cation. Another typical example of manganate and permanganate salts contain alkali earth, M′ cations, other typical examples includes a cation, selected from the group consisting of the transition metal cations, or containing cations of group III, group IV (including organic cations) and group V elements.

In the preparation of the Super-iron battery, the new cathode formulation is placed in contact with a conductive material, such as graphite, carbon black or a metal. The electrically neutral ionic conductor utilized in the battery according to the present invention, comprises a medium that can support current density during battery discharge. A typical representative ionic conductor is an aqueous solution preferably containing a high concentration of a hydroxide such as KOH. In other typical embodiments, the electrically neutral ionic conductor comprises common ionic conductor materials used in batteries which include, but are not limited to an aqueous solution, a non-aqueous solution, a conductive polymer, a solid ionic conductor and a molten salt, and the cell may include gas separator means such as vent or a void space for preventing the build-up in the cell of oxygen, hydrogen and other gases, as well as means to impede transfer of chemically reactive species, or prevent electric contract between the anode and Fe(VI) salt cathode. Said means includes, but is not limited to a membrane, a ceramic frit, a non-conductive separator configured with open channels, grids or pores or agar solution; such means being so positioned as to separate said half cells from each other.

The anode of the battery may be selected from the known list of metals capable of being oxidized, typical examples being zinc, lithium; common battery anodes such as cadmium, lead and iron; high capacity metals such as: aluminum, magnesium, calcium; and other metals such as copper, cobalt, nickel, chromium, gallium, titanium, indium, manganese, silver, cadmium, barium, iron, tungsten, molybdenum, sodium, potassium, rubidium and cesium. The anode may also be of other typical constituents capable of being oxidized, examples include, but are not limited to hydrogen, (including but not limited to metal hydrides), inorganic salts, and organic compounds including aromatic and non-aromatic compounds. The anode may also be of other typical constituents used for lithium-ion anodic storage, examples include, but are not limited to lithium-ion in carbon based materials and metal oxides.

An electric storage battery using the new cathode formulation according to the invention may be rechargeable by application of a voltage in excess of the voltage as measured without resistive load, of the discharged or partially discharged cell.

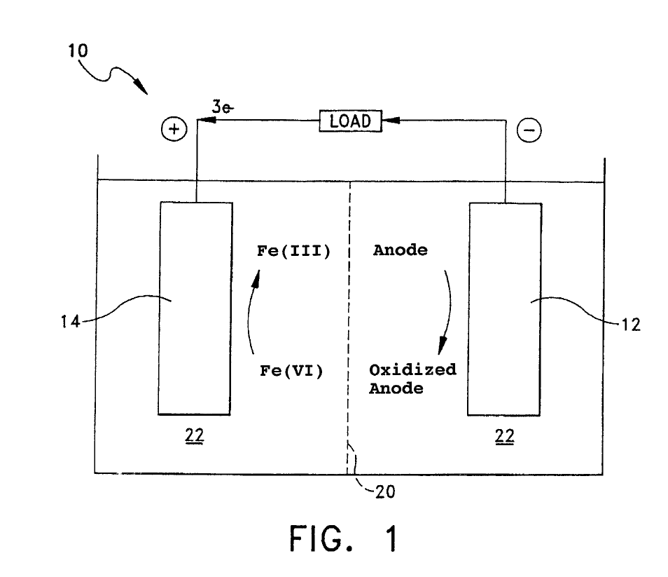

### DETAILED DESCRIPTION OF FIG. 1

FIG. 1 illustrates schematically an electrochemical cell 10 based on an Fe(VI) half cell, an electrically neutral ionic conductor and an anode. The cell contains an electrically neutral ionic conductor 22, such as a concentrated aqueous solution of KOH, in contact with an Fe(VI) cathode 14 in form of a pressed pellet containing graphite powder and solid K₂FeO₄. Reduction of Fe(VI) ions such as in the form of FeO₄²⁻ anions, is achieved via electrons available from the electrode 14. The anode electrode 12, such as in the form of metal is also in contact with the electrically neutral ionic conductor 22. Electrons are released in the oxidation of the anode. Optionally, the cell may contain an ion selective membrane 20 as a separator, for minimizing the non-electrochemical interaction between the cathode and the anode.

The invention will be hereafter illustrated by the following Examples, it being understood that the Examples are presented only for a better understanding of the invention without implying any limitation thereof, the invention being covered by the appended claims.

The methods of the present invention are described in further detail with reference to the following, non-limiting Examples. As is apparent from the comparative examples, significant increases in lifetime may be obtained using new cathode formulations for super-iron batteries. Although the examples used batteries of specific anode, or cell shape, it will be appreciated by those skilled in the art that the increase in performance may be obtained regardless of the cell size. Because some of the above new formulations perform better than others, it may be desirable to combine such conductors or additives to enhance the overall cell performance. It will be understood by those who practice the invention and by those skilled in the art, that various modifications and improvements may be made to the invention without departing from the spirit of the disclosed concept.

### EXAMPLE 1.

Experimental super-iron syntheses were carried out, the object being to improve the super-iron salt lifetime through control of the salt dryness. Presented at the end of this example are representative detailed preparation procedures for two super-iron salts, K₂FeO₄ and BaFeO₄. The preparations include steps in which these salts are extracted from contact with solutions that contain water. The degree of dryness of these salts is readily controlled by the application of a vacuum and the temperature and length of drying time. The water removal can be measured by the mass loss of the salt. The purity and charge capacity of the prepared super-iron salt can be determined by chemical redox titration, to determine the valence state of the iron in the salt. Also presented at the end of this example are representative detailed titration analysis procedure. In this example, experiments follow in which it is shown that control of the degree of dryness increases the super-iron salt lifetime.

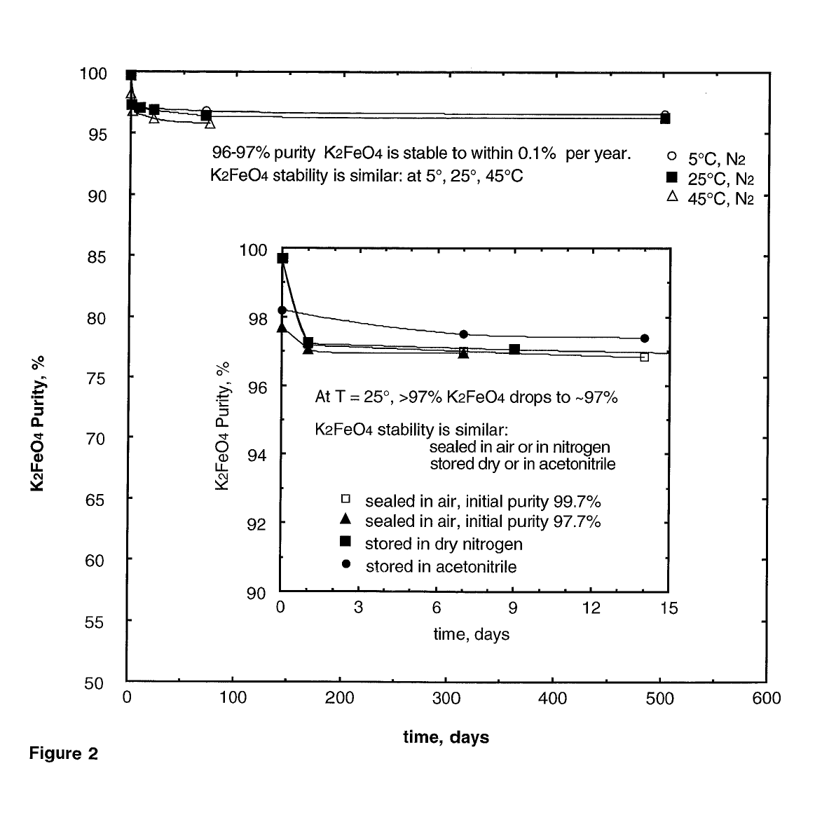

FIG. 2 presents the long term stability of K₂FeO₄ salt, as determined by the below chromite analysis, after sealing the salt in a variety of conditions. As shown in the FIG. 2 inset, K₂FeO₄ appears to be stable whether sealed under dry N₂ or sealed in air, and is also stable under acetonitrile (and a variety of other organic electrolytes. K₂FeO₄, synthesized as described below is stable when prepared to ˜97% dryness, whereas when prepared to a dryness of over 97-99%, tends to fall to ˜96.5% purity, at which point no further fall is observed for the duration of the experiment (over 1 year). The less than 97% purity K₂FeO₄, prepared as described, is particularly robust, and the long-term stability (over 1 year) is presented in FIG. 2.

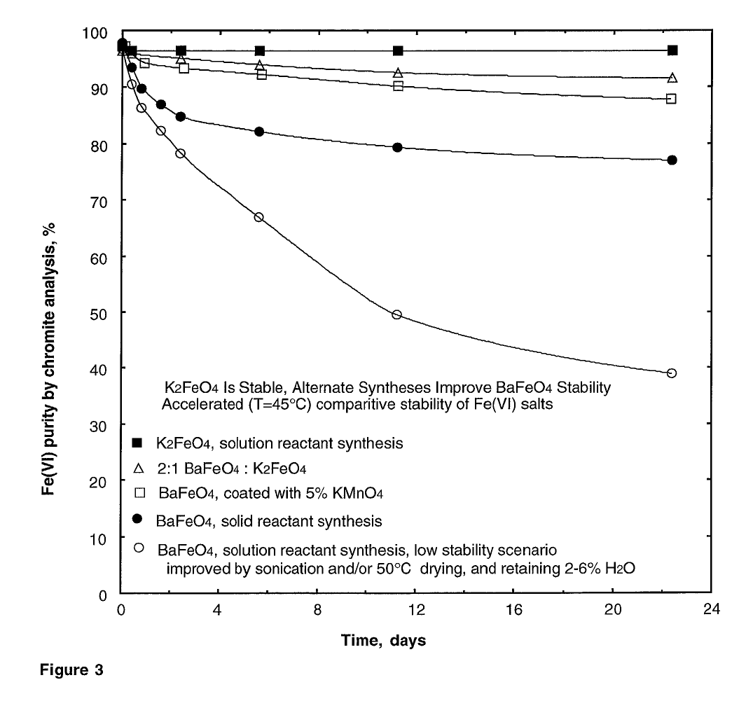

Table 1 measures the 3 electron capacity of BaFeO₄, as determined by chromite analysis. A high 3 electron capacity is preferred, to provide a high battery storage capacity. As shown in Table 1, over drying the BaFeO₄, when prepared according to the below described synthesis, leads to a diminished 3 electron capacity. The general drying range to produce 68% to 99% pure BaFeO₄, is preferred and the range of 88% to 98% BaFeO₄ is particularly preferred. FIG. 3 shows that with the described formulation conditions of this example, whereas the prepared potassium super-iron, K₂FeO₄, is stable in time, the lifetime of the prepared barium super-iron, BaFeO₄, is less stable, and that after an initial drop, acetonitrile has a stabilizing effect on BaFeO₄. A stable cathode salt is preferred to formulate a stable battery.

Table 1. The retained 3 electron capacity of BaFeO₄ salts synthesized to various degrees of dryness with purity measured by chromite analysis. Observed relative trends in vacuum drying time to reach a given level of purity are represented, and absolute measured drying time varies with the degree of vacuum pumping applied.

| Vacuum | room temperature | Analyzed BaFeO₄ |
|---|---|---|
| drying time | storage time | purity |
| 2 hour drying | 0 hour | 68.1% (Fe(VI) salt still |
| | | visibly wet) |
| 4 hour | 0 hour | 88.2% |
| 8 hour | 0 hour | 96.8% |
| 18 hour | 0 hour | 99.5%. |
| 24 hour | 0 hour | 93.1% (initial red appearance of |
| | | of Fe(III)). |
| 120 hour | 0 hour | 88.3% (increasing rust |
| | | appearance). |
| 2 hour drying | 0 hour | 68.1% |
| 2 hour drying | 7 days | 65.1% |
| 4 hour drying | 0 hour | 88.2% |
| 4 hour drying | 7 days | 86.3% |
| 8 hour drying | 0 hour | 96.8% |
| 8 hour drying | 7 days | 95.2% |
| 18 hour drying | 0 hour | 99.5% |
| 18 hour drying | 7 days | 84.4% |

In the preparation of the K₂FeO₄ salt, one liter of KOH concentrated solution is prepared with Barnstead model D4742 deionized water from 0.620 kg of KOH pellets from Frutarom, Haifa, Israel (Analytical reagent KOH with ˜14% water, <2% K₂CO₃, and <0.05% Na, <0.03% NH₄OH, and 0.01% or less of other components). The solution is converted to potassium hypochlorite by reaction with chlorine. The Cl₂ is generated in-house within a 2 liter Woulff (spherical) flask (made by Schott of Duran glass) with fritted glass connections. The glass connections are attached to a 1 liter dropping flask with pressure equalizer inlet (with a burette controlled liquid inlet and another connection is to a gas-outlet. In the Woulff flask is 0.25 kg KMnO₄ (99% CP grade, Frutarom), and from the dropping flask 1.13 liter of 37% HCl (AR grade, Carlo-Erba) is added dropwise to the KMnO to generate chlorine is in accord with:

KMnO₄+8HCl→MnCl₂.4H₂O++KCl+5/2Cl₂ (6)

Droplets, HCl and water are removed from the evolved Cl₂, through a series of 2 liter Dreschel (gas washing) flasks connected in series. The first and third are empty (to prevent backflow); the second contains water (to remove HCl), the fourth contains 95-98% H₂SO₄ (to remove water), and the fifth flask contains glass wool (to remove droplets). The evolved, cleaned Cl₂ flows into a reaction chamber (a sixth Dreschel flask containing the concentrated KOH solution, and surrounded by an external ice-salt bath) where it is stirred into concentrated KOH solution. Excess gas is trapped within a final flask containing waste hydroxide solution. Chlorination of the KOH solution generates hypochlorite, which is continued until the weight of the concentrated KOH solution has increased by 0.25 kg, over a period of approximately 90 minutes, in accord with:

2KOH+Cl₂→KClO+KCl+H₂O (7)

This hypochlorite solution is cooled to 10° C. Alkalinity of the solution is increased, and KCl removed, through the addition of 1.46 kg KOH pellets, added slowly with stirring, to permit the solution temperature to rise to no more than 30° C. Stirring is continued for 15 minutes, and the solution is cooled to 20° C. The precipitated KCl is removed by filtration through a 230 mm diameter porcelain funnel using a glass microfibre filter (cut from Whattman 1820-915 GF/A paper).

A ferric salt is added to the hypochlorite solution, reacting to Fe(VI), as a deep purple FeO₄^{2 -} solution. An external ice-salt bath surrounds the solution to prevent overheating. Specifically, to the alkaline potassium hypochlorite solution at 10° C., is added 0.315 kg ground Fe(NO₃)₃.9H₂O (98% ACS grade, ACROS). In alkaline solution, the ferric nitrate constitutes hydrated ferric oxides or hydroxides, summarized as:

Fe(NO₃)₃.9H₂O+30H^{-→Fe(OH)}₃+9H₂O+3NO₃— (8)

which is oxidized by hypochlorite to form the solvated Fe(VI) anion, FeO₄²⁻:

Fe(OH)₃+3/2ClO⁻+2OH⁻→FeO₄²⁻+3/2Cl⁻+5/2H₂O (9)

During the ferric addition, a surrounding ice-salt bath is applied to maintain the solution temperature below 35° C. Following this addition, the solution is stirred for 60 minutes, with the solution temperature controlled at 20° C. For potassium salts, the overall reaction is summarized by equations 8 and 9 as:

Fe(NO₃)₃.9H₂O+3/2KClO+5KOH →K₂FeO₄²+3/2KCl+3KNO₃ +23/2H₂O (10)

Following this, the KOH concentration of the resultant Fe(VI) solution is increased to precipitate K₂FeO₄. Specifically into this solution is stirred 1.25 liter of 0° C., 9.6 molar KOH. After 5 minutes the suspension is (simultaneously) filtered onto two 120 mm P-1 sintered Duran glass filters (Schott).

The two precipitates are dissolved in 1.6 liter of 2.57 molar KOH, and quickly filtered, through a funnel with 2 layers of GF/A filter paper of 230 mm diameter, directly into 1.7 liter of 0° C. 12 molar KOH. The solution is stirred for 15 minutes at 3° C., and then the solution is filtered onto a 90 mm P-2 sintered Duran glass filter (Schott). The wet K₂FeO₄ is dissolved in 0.850 liter of 0° C. 2.57 molar KOH solution, and quickly filtered on 2 sheets of filter paper GF/A 150 mm diameter, in a filtering flask which contains 2.7 liters of a 12 molar KOH solution.

From this point, two grades of K₂FeO₄ are produced. The first generates higher yield, 90 g K₂FeO₄, at a purity of 96-97%. The second generates 80 g of K₂FeO₄ at even higher purity 97-98.5%. Both exhibit effective battery discharge. In both procedures, the wet K₂FeO₄ is redissolved in 0.850 liter of 0° C. 2.57 molar KOH solution, and quickly filtered on 2 sheets of filter paper GF/A 150 mm diameter, into a filtering flask containing 2.7 liter 12 molar KOH solution. The resulting suspension is stirred for 15 minutes at 0° C. and is filtered through a P-2 sintered glass filter. This redissolution/filtering step is repeated in the second (highest purity) procedure. In either procedure, on the same filter, the precipitate is successively rinsed: 4× (four times with) 0.16 liter n-hexane; 2×0.08 liter isopropyl alcohol; 8×0.15 liter methanol, and finally 3×0.080 liter diethyl ether. The K₂FeO₄ is dried for 30-60 minutes under room temperature vacuum (at 2-3 mbar).

In the preparation of the BaFeO₄ salt, the dried K₂FeO₄ product has been found to be stable in time, and may be used for BaFeO₄ synthesis directly or after storage. In an aqueous solution, referred to as solution II, 0.08 kg K₂FeO₄ was dissolved at 0° C. in 1.6 liter 2% KOH solution (37.6 gram KOH in 1.6 liter water, with CO₂ removed by argon flow through the solution). BaFeO₄ was synthesized by utilizing the higher alkaline insolubility of barium ferrate(VI) compared to that of potassium ferrate(IV). We have observed effective Fe(VI) precipitates occur starting with barium nitrate, chloride, bromide, acetate or hydroxide salts. In this synthesis, 0.210 kg Ba(OH)₂×8H₂O (98%, Riedel-de-Haen) was dissolved in 5 liter deionized water, with CO₂ removed by argon flow, at 0° C., and the solution is filtered through GF/A filter paper (solution II). Solution I is then filtered through GF/A filter paper (150 mm) into the solution II, with stirring at 0° C. (using an ice bath). Stirring is continued in the mixture for 30 minutes. The mixture obtained was filtered on a single funnel with GF/A glass microfibre paper, diameter of 230 mm, and then, the residue of BaFeO₄ was washed with 10 liter cold distilled water without CO₂, until the BaFeO₄ reached pH=7. The resultant BaFeO₄ is dried for 16-24 hours under room temperature vacuum (at 2-3 mbar) and yields 90-93 g of 96-98% purity BaFeO₄ as determined by chromite analysis, and is herein referred to as BaFeO₄ synthesized by precipitation from dissolved K₂FeO₄.

In the analysis, the percentage of the original iron containing material which is converted to solid Fe(VI) salt was determined by the chromite method [13] to probe the iron valence state, measured through Fe(VI) redissolution as FeO₄²⁻ to oxidize chromite, and in which the chromate generated is titrated with a standard ferrous ammonium sulfate solution, using a sodium diphenylamine sulfonate indicator:

Cr(OH)₄⁻+FeO₄²⁻+3H₂O→Fe(OH)₃(H₂O)₃+CrO₄²⁻+OH⁻ (11)

### EXAMPLE 2.

Alternate experimental super-iron formulations were carried out, the object being to improve the barium super-iron salt lifetime.

Stability measurements of Fe(VI) purity, as determined by chromite analyses, were performed following elevated temperature (45° C.) storage to enhance observation of any material instability. 45° C. stability after storage of K₂FeO₄, BaFeO₄ and K₂FeO₄/BaFeO₄ mixed salts, was determined by chromite analysis. As seen in FIG. 3, synthesized K₂FeO₄ is stable at this temperature. The observed 45° C. stability of the solution reactant synthesized BaFeO₄ is highly variable, varying strongly with small changes in synthesis conditions. A typical case of a less stable solution reactant synthesized BaFeO₄ is included in the figure. The solid reactant synthesized BaFeO₄ as will be described below, is consistently more stable as exemplified in the figure, and as shown is further stabilized when ground as a 2:1 mix with solid K₂FeO₄.

The transition to the improved BaFeO₄ formulation was accomplished in several steps, and is described in lieu of the solution phase BaFeO₄ formulation which was described in Example 1 as the reaction of Solutions I and II. We have found that solid K₂FeO₄ reacts with a suspension (a supersaturated aqueous solution) of Ba(OH)₂ to yield a mixture of pure BaFeO₄ and pure K₂FeO₄. A suspension is prepared of 81.2 g (0.26 moles) of Ba(OH)₂ in 2 liter of 10 molal KOH. To this suspension solid 51.0 g K₂FeO₄ (0.26 moles) is added, and stirred 30 minutes. The K₂FeO₄ is highly insoluble in the solution, and is converted towards BaFeO₄. The resultant powder, still undissolved, is removed by filtration, and the precipitate washed with organic solvents, as previously described for similar purification step in K₂FeO₄ preparation [5] The reaction yields a pure mixture of Fe(VI) salts (as determined by chromite, FTIR and inductively coupled plasma analysis) containing approximately a 4:1 ratio of BaFeO₄ to K₂FeO₄. We find that this BaFeO₄ synthesized from insoluble K₂FeO₄ has a more stable 3 electron capacity than BaFeO₄ synthesized by precipitation from dissolved K₂FeO₄. In variations of this synthesis BaFeO₄ has been prepared from a K₂FeO₄ powder sorted by particle size using screen sieves, and it is found that over 100 micrometer particle K₂FeO₄, forms a further improved stability BaFeO₄ powder compared to starting with under 35 micrometer K₂FeO₄. In other synthesis variations which did not exhibit improvement of the BaFeO₄ product, the relative amount of K₂FeO₄ powder to barium hydroxide has been changed, and/or a concentrated Ba(OH)₂.8H₂O solution not containing KOH is used.

No room temperature reaction was observed for a 1:1 mole ratio of BaO to K₂FeO₄, when ground together for 3 hours. However, spontaneous conversion to BaFeO₄ is achieved by replacing the BaO with conventional solid Ba(OH)₂×8H₂O. In this case, a 1:1 mole ratio of Ba(OH)₂×8H₂O to K₂FeO₄ yields upon grinding an immediate reaction to BaFeO₄. Samples were analyzed using a Bruker VECTOR 22 FTIR spectrometer. FTIR analysis of the ground solid BaO/K₂FeO₄ mixture yields the spectra of pure K₂FeO₄ (a single absorption at 807 cm⁻¹), without any of the three BaFeO₄ identifying absorptions which occur in the same region. At room temperature, the presence of bound water, included within the hydrated solid Ba(OH)₂ salt, facilitates the reaction of the ground mixture, yielding pure BaFeO₄ with the properly proportioned BaFeO₄ absorption peaks at 780, 812 and 870 cm⁻¹. However, this solid K₂FeO₄/solid Ba(OH)₂×8H₂O reaction yields a wet paste, which without being bound to any theory is a suspension of solid BaFeO₄ in 13.9 molal aqueous KOH, due to the dissolution product of 2 moles of KOH per 8 moles (0.14 kg) H₂O generated, in accord with:

K₂FeO₄+Ba(OH)₂×8H₂O→BaFeO₄+2KOH+8H₂O (12)

Intermediate syntheses demonstrated solid BaO could drive the reaction to BaFeO₄, when combined with as little as 50 mole percent of Ba(OH)₂×8H₂O. The resultant mix, equivalent to the tetrahydrate Ba(OH)₂×4H₂O, are sufficient to support a substantially complete (96-97%) room temperature conversion of the K₂FeO₄ to BaFeO₄, and generate a viscous dough-like blend of solid BaFeO₄ mixed with supersaturated KOH, which without being bound to any theory is in accord with generation of only 4 moles of H₂O for 2 moles of KOH:

K₂FeO₄+0.5BaO+0.5Ba(OH)₂×8H₂O→BaFeO₄+2KOH+4H₂O (13)

Summaries of the ICP, FTIR and chromite analysis results are presented in Table 2 for a typical solution phase reactant synthesized BaFeO₄, as well as for repeat syntheses of solid reactant synthesized BaFeO₄. Inductively coupled plasma analysis of K₂FeO₄ and BaFeO₄ samples was conducted with an ICP Perkin-Elmer Optima 3000 DV to determine the relative weight percent, and mole percent compositions of the principal cations in the sample. The ICP suggests that the Fe(VI) content within the solid reactant synthesized BaFeO₄ contains 3-4% K₂FeO₄, and the complete analyses provide evidence that the solution reactant and solid reactant synthesized BaFeO₄ are of comparable high purity, averaging an Fe(VI) content of 97 to 98%.

Table 2. Inductively coupled plasma, ICP, determined elemental constituents, chromite Fe(VI) content determination, and FTIR BaFeO₄ purity determination measured in BaFeO₄ samples. From the ICP mass constituents are determined the mole ratio of principal cations. Solution reactant samples are prepared from aqueous solutions of K₂FeO₄ and Ba(OH)₂. Solid reactant samples are prepared by grinding a 1:0.5:0.5 equivalent mix of K₂FeO₄, Ba(OH)₂×8H₂O and BaO.

| BaFeO₄ Sample | | | | |
|---|---|---|---|---|
| purity | ICP mole ratio | | Fe(VI) purity | BaFeO₄ |
| analysis | Ba/Fe | 2K/Fe | chromite analysis | FTIR |
| solution reactants | 0.997 | 0.003 | 98.1% | 98.0% |
| solid reactants #1 | 0.947 | 0.035 | 99.2% | 98.2% |
| solid reactants #2 | 0.955 | 0.040 | 97.2% | 96.5% |
| solid reactants #3 | 0.948 | 0.030 | 99.4% | 97.8% |

In an alternate formulation, the residue of BaFeO₄ described in the BaFeO₄ preparation in Example 1 is dried, rather than at room temperature, at 50° C. for 10 hours. In a second alternate preparation the residue of BaFeO₄ is dried for 12 hours at room temperature while simultaneously undergoing sonication by placement in a sonicator. To test these alternate BaFeO₄ preparations, the stability of barium-super iron salts were measured at 45° C., to accelerate the testing of the salt lifetime. These high temperature or sonicated dried BaFeO₄ have a more stable 3 electron capacity than BaFeO₄ synthesized by precipitation from dissolved K₂FeO₄.

We have found that a barium super-iron salt prepared with various additives improves the barium super-iron salt lifetime. In alternate preparations, prior to drying, an additional solution is prepared (as 2 g salt per 10 ml deionized water) of either CuSO₄ or sodium silicate (also known as water glass) and mixed with (40 g of) the wet residue of BaFeO₄, and than dried as described in the last example. Both of these modified BaFeO₄ salts exhibited improved stability.

We have also found that a coating of permanganate improves the BaFeO₄ robustness. An example, a five percent coating of KMnO₄ on BaFeO₄ is prepared as follows: 4.74 g KMnO₄ (30.0 millimoles) was dissolved by stirring in 0.33 liter of acetonitrile. 90.0 g (0.348 moles) BaFeO₄ powder is added. BaFeO₄ is insoluble in this solution and the suspension was stirred for 30 minutes. Acetonitrile is removed under vacuum, initially with stirring for 60 minutes to remove the majority of the acetonitrile. This is continued without stirring for 3 hours to fully dry the 5% KMnO₄ coated BaFeO₄. The open square data curve in FIG. 3, summarizes data that a BaFeO₄ formulation prepared with a coating according to the above procedure has a more stable 3 electron capacity than. the uncoated formulation.

### EXAMPLE 3.

Alternate experimental super-iron preparations were formulated and tested, in which the Super-iron salt is formulated with more than one different cation, the object being to improve the super-iron salt lifetime. In one such series of experiments, a solution such as solution II described in Example 1, and comprised of dissolved barium nitrate, chloride, acetate or hydroxide salts, is replaced by a solution containing both dissolved strontium salts and dissolved barium salts, and the product salt then contains both strontium and barium cations as analyzed by ICP (Inductively Coupled Plasma spectroscopy). In a specific example of this series, a super-iron salt was prepared from a solution containing 25% barium acetate and 75% strontium acetate and the resultant super-iron powder exhibited a relative 26% higher capacity after 7 day storage at 45° C., than the similarly prepared pure barium super-iron powder. In a second series of experiments, a super-iron salt is prepared containing both potassium and barium cations, using the same type of procedure described in Example 1, but employing a smaller relative quantity of solution II, and in a similar manner as shown in FIG. 3, a mixture of BaFeO₄ and K₂FeO₄ exhibits an improved stability compared to BaFeO₄ alone.

### EXAMPLE 4.

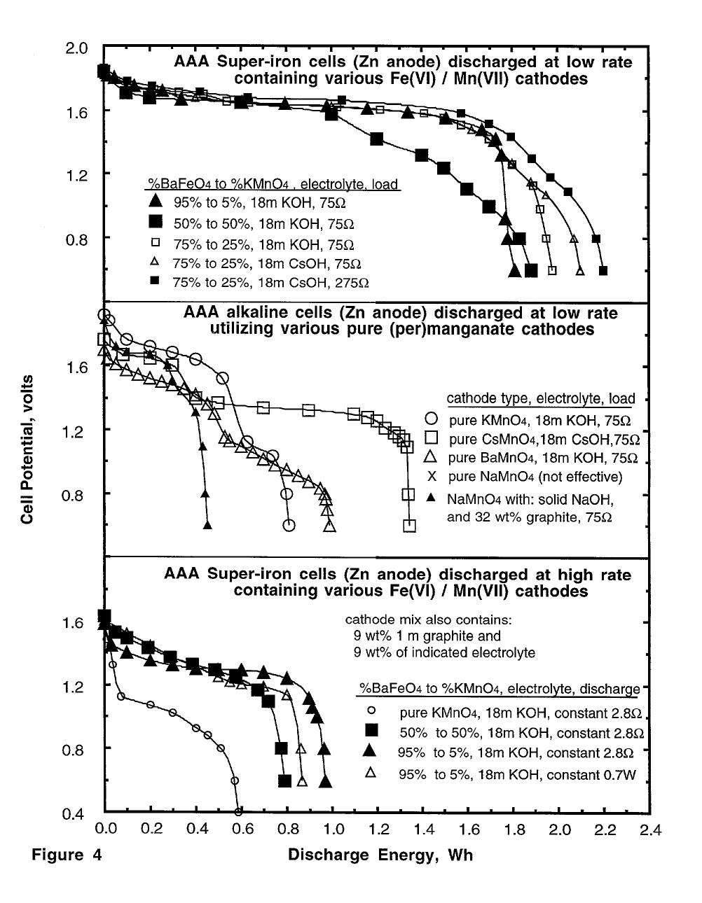

Experimental super-iron formulations were carried with permanganate and manganate, the object being to improve the super-iron lifetime during discharge. FIG. 4 summarizes the measured storage capacity of AAA cells containing different cathode formulations, each containing the same, conventional, alkaline zinc gel anode, and discharged under a constant load of either 2.8 or 75 ohms. A cathode formulation which provides a larger measured lifetime during discharge is preferred over a formulation providing a shorter lifetime during discharge which is evident as a lower capacity. As seen in the midsection of FIG. 4, a cathode formulation consisting of only a manganate or permanganate salt exhibits a low discharge capacity. As seen in the figure top section for 75Ω discharges, and in the bottom section for 2,8Ω discharges, a cathode formulation containing an Fe(VI) salts, and a permanganate salt discharges to a high discharge capacity. Finally, as also seen in the top section of the figure, a Fe(VI) formulation containing a CsOH solution, rather than a KOH solution, discharges to the highest exhibited capacity. Alternately, the CsOH can be added directly as a solid in 1 to 25 wt% mixture with the Fe(VI) salt.

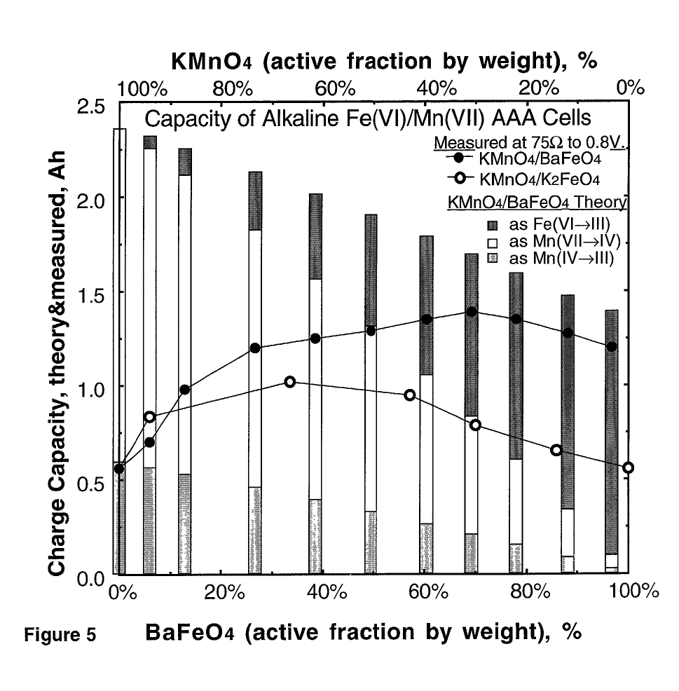

In principal, permanganate can undergo a total of a 4e⁻alkaline cathodic reduction to Mn(III), the final reduction from Mn(IV) to Mn(II) is common in conventional alkaline batteries. FIG. 5, includes the theoretical (intrinsic) storage capacity of cells containing a variety of relative compositions of BaFeO₄ and KMnO₄. These capacities are calculated from the mass of KMnO₄ and BaFeO₄ in the cell, determined from a theoretical 4 Faradays mole⁻¹ Mn(VI→III), and 3 F mol⁻¹ Fe(VI→III), reduction, and subsequently converted to ampere hours. As is evident in FIG. 5, KMnO₄ has a large theoretical cathodic capacity, but the experimental cell exhibits inefficient charge transfer measured as a low experimental capacity. However without being bound to any theory, as seen in the figure inclusion of even small amounts of the BaFeO₄ or K₂FeO₄ Fe(VI) salt enhances charge transfer, yielding substantially higher experimental capacities. As also evident in the figure, a wide range of BaFeO₄/KMnO₄ compositions, including over 25 weight percent KMnO₄ compared to BaFeO4 or K₂FeO₄, exhibit in the battery a higher discharge capacity, and therefore an extended lifetime during discharge.

1. A battery comprising two half-cells which are in an electrochemical contact with one another through an electrically neutral ionic conductor, wherein one of said half-cells comprises an anode and the other half-cell comprises at least 1% of weight of a Fe(VI) salt, whereby electrical discharge or charge is accomplished via an electrochemical charge insertion to or from a valence state of iron salt less than Fe(VI), and a stablizing formulation increases the lifetime of the Fe(VI) salt.

2. The battery according to claim 1, wherein said stablizing formulation is a Fe(VI) salt which contains water, and is partially dry.

3. The battery according to claim 2, wherein the Fe(VI) salt is between 68% and 99% dry.

4. The battery according to claim 2, wherein the Fe(VI) salt is between 88% and 97% dry.

5. The battery according to claim 1, wherein said stablizing formulation is an Fe(VI) salt, prepared from a solid, different Fe(VI) salt immersed, but highly insoluble, in a solution prepared from a second salt.

6. The battery according to claim 1, wherein said stablizing formulation is an Fe(VI) salt, prepared from all solid reactants, using a solid, different Fe(VI) salt and a solid, second salt.

7. The battery according to claims 5 or 6, wherein said different Fe(VI) salt is chosen from the list of K₂FeO₄, BaFeO₄ or SrFeO₄.

8. The battery according to claims 5 or 6, wherein said second salt contains one or more of the cations chosen from the list of Ba, Sr, K, Na, Li, C, Rb, H, Be, Mg, Ca, La, Ce, Ce, Hg, Cu, Zn, Ag, Fe, Cr, Mn, Ni, Co, Al, In, Ga, Sn, Pb, Sn, Pb, ammonium, or tetra methyl, ethyl, propyl or butyl ammonium.

9. The battery according to claims 5 or 6, wherein said second salt contains one or more of the anions chosen from the list of hydroxides, oxides, nitrates, nitrites, phosphates, halides, halates, perhalates, halites, hypohalites, acetates, acetylsalicylates, chalcogenides, chalcogeniates, aluminates, hydrides, amides, antomonides, arsenates, azides, benzoates, borates, carbides, carbonates, dithiones, chloroplatinates, chromates, citrates, fluosilicates, fluosulfonates, formates, hydrides, nitrides, germanates, hydrides, laurates, manganates, malonates, permanganates, molybdates, myristates, oxalates, palmitates, salicylates, silicates, silicides, stearates, succinates, sulfites, tartrates, thiocyanates, thionates, titanates, or tungstates.

10. The battery according to claims 6, wherein said solid, second salt contains one or more water or other solvent molecules.

11. The battery according to claim 1, wherein the Fe(VI) salt is-coated with a permanganate salt to improve the salt lifetime.

12. The battery according to claim 11, wherein said permanganate salt is an alkali salt, alkali earth salt or includes a cation, selected from the group consisting of the transition metal cations, or containing cations of group III, group IV (including organic cations) and group V elements. In a preferred embodiment this coating is with a potassium permanganate salt.

13. The battery according to claim 11, wherein said coating comprises 0.1% to 3% of the formulation weight.

14. The battery according to claim 11, wherein said coating comprises 3% to 25% of the formulation weight.

15. The battery according to claim 11, wherein said coating comprises 25% to 99% of the formulation weight.

16. The battery according to claim 11, wherein said permanganate salt is potassium permanganate.

17. The battery according to claim 1, wherein the Fe(VI) salt is formulated with more than one different cation.

18. The battery according to claim 1, wherein the Fe(VI) salt is formulated to include solid CsOH, comprising a weight fraction between 1% and 25% of the combined mass with the Super-iron salt.

19. The battery according to claim 1, wherein the Fe(VI) salt is formulated to include a CsOH solution, comprising a weight fraction between 1% and 25% of the combined mass with the Super-iron salt.

20. The battery according to claim 1, wherein the Fe(VI) salt is formulated to include a manganate or a permanganate salt, comprising a weight fraction between 25% and 99% of the combined mass with the Super-iron salt.

21. The battery according to claim 20, wherein said permanganate salt is an alkali salt, alkali earth salt or includes a cation, selected from the group consisting of the transition metal cations, or containing cations of group III, group IV (including organic cations) and group V elements.

22. The battery according to claim 20, wherein said manganate salt is an alkali salt, alkali earth salt or includes a cation, selected from the group consisting of the transition metal cations, or containing cations of group III, group IV (including organic cations) and group V elements.

23. The battery according to claim 20, wherein said permanganate salt is potassium permanganate.

24. The battery according to claim 1, wherein the Fe(VI) salt is formulated to include a silicate salt, comprising a weight fraction between 1% and 25% of the combined mass with the Super-iron salt.

25. The battery according to claim 24, wherein said silicate salt is sodium silicate.

26. The battery according to claim 1, wherein the Fe(VI) salt is formulated to include a copper salt, comprising a weight fraction between 1% and 25% of the combined mass with the Super-iron salt.

27. The battery according to claim 26, wherein said copper salt is copper sulfate.

28. The battery according to claim 1, wherein said stabilizing formulation is a Fe(VI) is formed by rapid drying means.

29. The battery according to claim 28, wherein said rapid drying means is drying at above room temperature.

30. The battery according to claim 28, wherein said rapid drying means is drying with simultaneous sonication.
